(19) United States
(12) Patent Application Publication
(10) Pub. No.: US 2015/0163223 A1
(43) Pub. Date: Jun. 11, 2015

(54) Managing Resources In A Distributed Computing Environment

(71) Applicant: International Business Machines Corporation, Armonk, NY (US)

(72) Inventors: Bin Cao, Rochester, MN (US); Jessica R. Eidem, Rochester, MN (US); Brian R. Muras, Rochester, MN (US)

(73) Assignee: International Business Machines Corporation, Armonk, NY (US)

(21) Appl. No.: 14/100,923

(22) Filed: Dec. 9, 2013

(51) Int. Cl. H04L 29/06; G06F 21/60

(52) U.S. Cl. CPC H04L 63/10; G06F 21/602

(57) ABSTRACT

Methods, apparatuses, and computer program products for managing resources in a distributed computing environment that includes a plurality of resources and a resource recycling unit for storing discarded resources are provided. Embodiments include a management system maintaining within a resource recycling unit, a plurality of discarded resources of the distributed computing environment. Embodiments also include the management system receiving from a user, a request for a resource of the distributed computing environment and in response to receiving the request, selecting a first discarded resource from the plurality of discarded resources of the resource recycling unit. Embodiments also include the management system providing the selected first discarded resource to the user.

### BACKGROUND OF THE INVENTION

1. Field of the Invention

The field of the invention is data processing, or, more specifically, methods, apparatuses, and computer program products for managing resources in a distributed computing environment.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Modern computing systems can include a plurality of machines that share resources with each other. Allocating resources to each machine, user, software application, or other consumer of computing resources can often be burdensome and difficult.

### SUMMARY

Methods, apparatuses, and computer program products for managing resources in a distributed computing environment that includes a plurality of resources and a resource recycling unit for storing discarded resources are provided. Embodiments include a management system maintaining within a resource recycling unit, a plurality of discarded resources of the distributed computing environment. Embodiments also include the management system receiving from a user, a request for a resource of the distributed computing environment and in response to receiving the request, selecting a first discarded resource from the plurality of discarded resources of the resource recycling unit. Embodiments also include the management system providing the selected first discarded resource to the user.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 sets forth a block diagram of automated computing machinery comprising an example computer useful in managing resources in a distributed computing environment according to embodiments of the present invention.

FIG. 5 sets forth a flow chart illustrating an example method for managing resources in a distributed computing environment according to embodiments of the present invention.

FIG. 6 sets forth a flow chart illustrating an additional example method for managing resources in a distributed computing environment according to embodiments of the present invention.

FIG. 7 sets forth a flow chart illustrating an additional example method for managing resources in a distributed computing environment according to embodiments of the present invention.

FIG. 8 sets forth a flow chart illustrating an additional example method for managing resources in a distributed computing environment according to embodiments of the present invention.

FIG. 9 sets forth a flow chart illustrating an additional example method for managing resources in a distributed computing environment according to embodiments of the present invention.

### DETAILED DESCRIPTION OF EXEMPLARY EMBODIMENTS

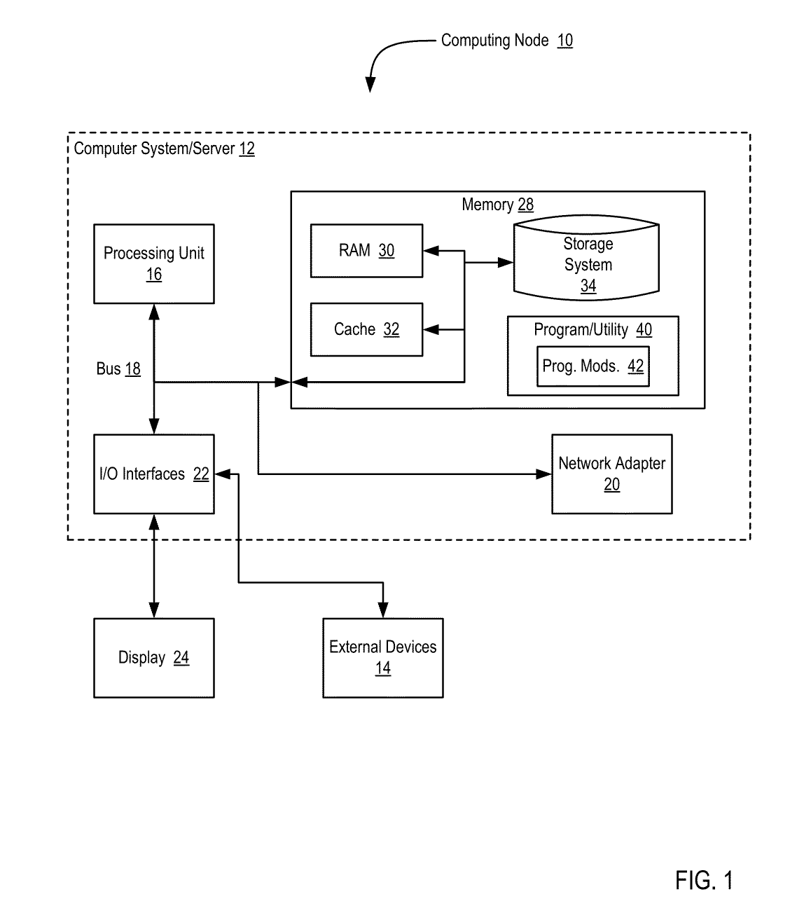

Example methods, apparatuses, and computer program products for managing resources in a distributed computing environment in accordance with the present invention are described with reference to the accompanying drawings, beginning with FIG. 1. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (‘SaaS’): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (‘Paas’): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (‘IaaS’): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 1, a schematic of an example of a cloud computing node is shown. Cloud computing node (10) is only one example of a suitable cloud computing node and is not intended to suggest any limitation as to the scope of use or functionality of embodiments of the invention described herein. Regardless, cloud computing node (10) is capable of being implemented and/or performing any of the functionality set forth hereinabove.

In cloud computing node (10) there is a computer system/server (12), which is operational with numerous other general purpose or special purpose computing system environments or configurations. Examples of well-known computing systems, environments, and/or configurations that may be suitable for use with computer system/server (12) include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (12) may be described in the general context of computer system executable instructions, such as program modules, being executed by a computer system. Generally, program modules may include routines, programs, objects, components, logic, data structures, and so on that perform particular tasks or implement particular abstract data types. Computer system/server (12) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server (12) in cloud computing node (10) is shown in the form of a general-purpose computing device. The components of computer system/server (12) may include, but are not limited to, one or more processors or processing units (16), a system memory (28), and a bus (18) that couples various system components including system memory (28) to processor (16).

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (‘ISA’) bus, Micro Channel Architecture (‘MCA’) bus, Enhanced ISA (‘EISA’) bus, Video Electronics Standards Association (‘VESA’) local bus, and Peripheral Component Interconnect (‘PCI’) bus.

Computer system/server (12) typically includes a variety of computer system readable media. Such media may be any available media that is accessible by computer system/server (12), and it includes both volatile and non-volatile media, removable and non-removable media.

System memory (28) can include computer system readable media in the form of volatile memory, such as random access memory (‘RAM’) (30) and/or cache memory (32). Computer system/server (12) may further include other removable/non-removable, volatile/non-volatile computer system storage media. By way of example only, storage system (34) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (18) by one or more data media interfaces. As will be further depicted and described below, memory (28) may include at least one program product having a set (e.g., at least one) of program modules that are configured to carry out the functions of embodiments of the invention.

Program/utility (40), having a set (at least one) of program modules (42), may be stored in memory (28) by way of example, and not limitation, as well as an operating system, one or more application programs, other program modules, and program data.

Each of the operating system, one or more application programs, other program modules, and program data or some combination thereof, may include an implementation of a networking environment. Program modules (42) generally carry out the functions and/or methodologies of embodiments of the invention as described herein.

Computer system/server (12) may also communicate with one or more external devices (14) such as a keyboard, a pointing device, a display (24), etc.; one or more devices that enable a user to interact with computer system/server (12); and/or any devices (e.g., network card, modem, etc.) that enable computer system/server (12) to communicate with one or more other computing devices. Such communication can occur via Input/Output (‘I/O’) interfaces (22). Still yet, computer system/server (12) can communicate with one or more networks such as a local area network (IAN), a general wide area network (‘WAN’), and/or a public network (e.g., the Internet) via network adapter (20). As depicted, network adapter (20) communicates with the other components of computer system/server (12) via bus (18). It should be understood that although not shown, other hardware and/or software components could be used in conjunction with computer system/server (12). Examples, include, but are not limited to: microcode, device drivers, redundant processing units, external disk drive arrays, RAID systems, tape drives, and data archival storage systems, etc.

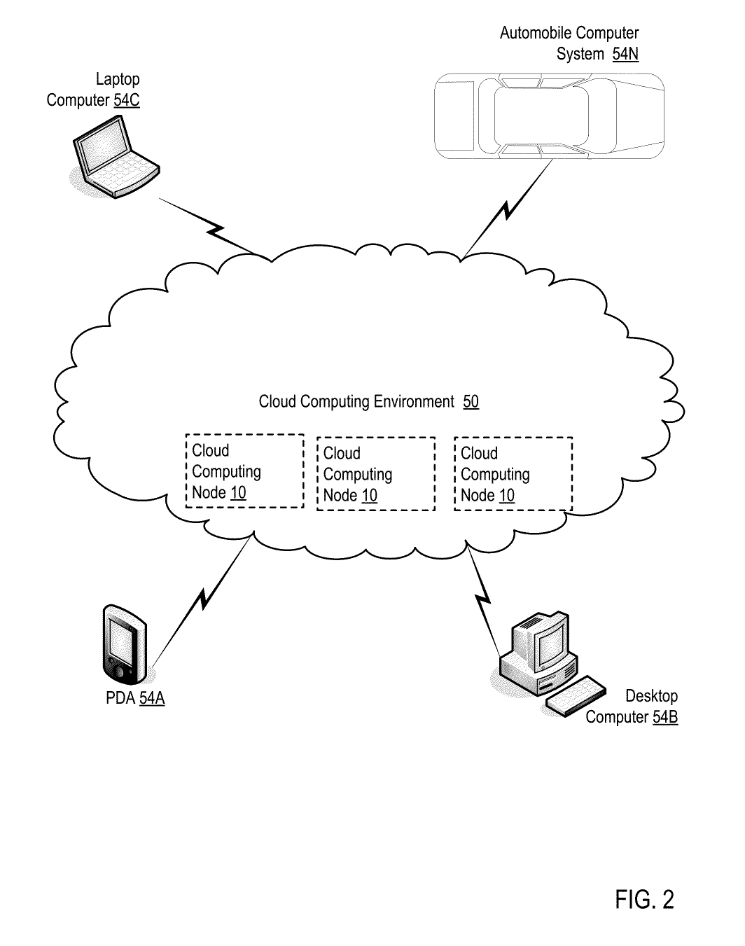

Referring now to FIG. 2, illustrative cloud computing environment (50) is depicted. As shown, cloud computing environment (50) comprises one or more cloud computing nodes (10) with which local computing devices used by cloud consumers, such as, for example, personal digital assistant (‘PDA’) or cellular telephone (54A), desktop computer (54B), laptop computer (54C), and/or automobile computer system (54N) may communicate. The cloud computing nodes (10) may communicate with one another. They may be grouped (not shown) physically or virtually, in one or more networks, such as Private, Community, Public, or Hybrid clouds as described hereinabove, or a combination thereof. This allows cloud computing environment (50) to offer infrastructure, platforms and/or software as services for which a cloud consumer does not need to maintain resources on a local computing device. It is understood that the types of computing devices (54A-N) shown in FIG. 2 are intended to be illustrative only and that computing nodes (10) and cloud computing environment (50) can communicate with any type of computerized device over any type of network and/or network addressable connection (e.g., using a web browser).

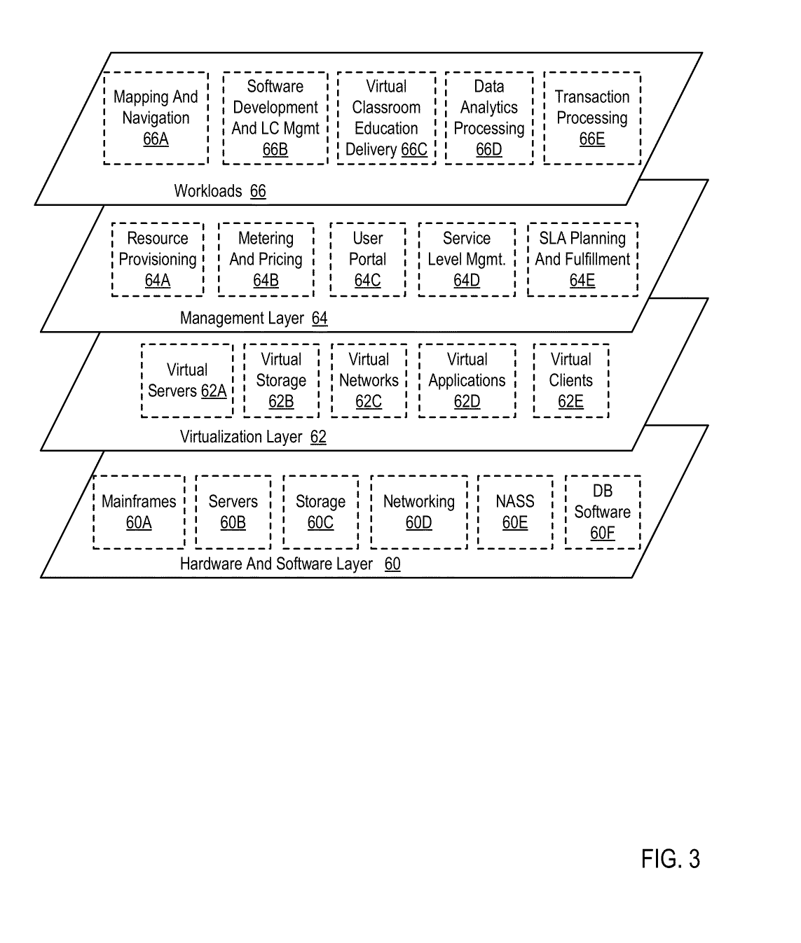

Referring now to FIG. 3, a set of functional abstraction layers provided by cloud computing environment (element 50 in FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer (60) includes hardware and software components. Examples of hardware components include mainframes (60A), in one example IBM® zSeries® systems; RISC (Reduced Instruction Set Computer) architecture based servers (60B), in one example IBM pSeries® systems; IBM xSeries® systems; IBM BladeCenter® systems; storage devices (60C); networks and networking components (60D). Examples of software components include network application server software (60E), in one example IBM WebSphere® application server software; and database software (60F), in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (62) provides an abstraction layer from which the following examples of virtual entities may be provided: virtual servers (62A); virtual storage (62B); virtual networks (62C), including virtual private networks; virtual applications (62D) and operating systems; and virtual clients (62E).

In one example, management layer (64) may provide the functions described below. Resource provisioning (64A) provides dynamic procurement of computing resources and other resources that are utilized to perform tasks within the cloud computing environment. Metering and Pricing (64B) provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal (64C) provides access to the cloud computing environment for consumers and system administrators. Service level management (64D) provides cloud computing resource allocation and management such that required service levels are met. Service Level Agreement (SLA) planning and fulfillment (64E) provides pre-arrangement for, and procurement of, cloud computing resources for which a future requirement is anticipated in accordance with an SLA.

Workloads layer (66) provides examples of functionality for which the cloud computing environment may be utilized. Examples of workloads and functions which may be provided from this layer include: mapping and navigation (66A); software development and lifecycle management (66B); virtual classroom education delivery (66C); data analytics processing (66D); and transaction processing (66E).

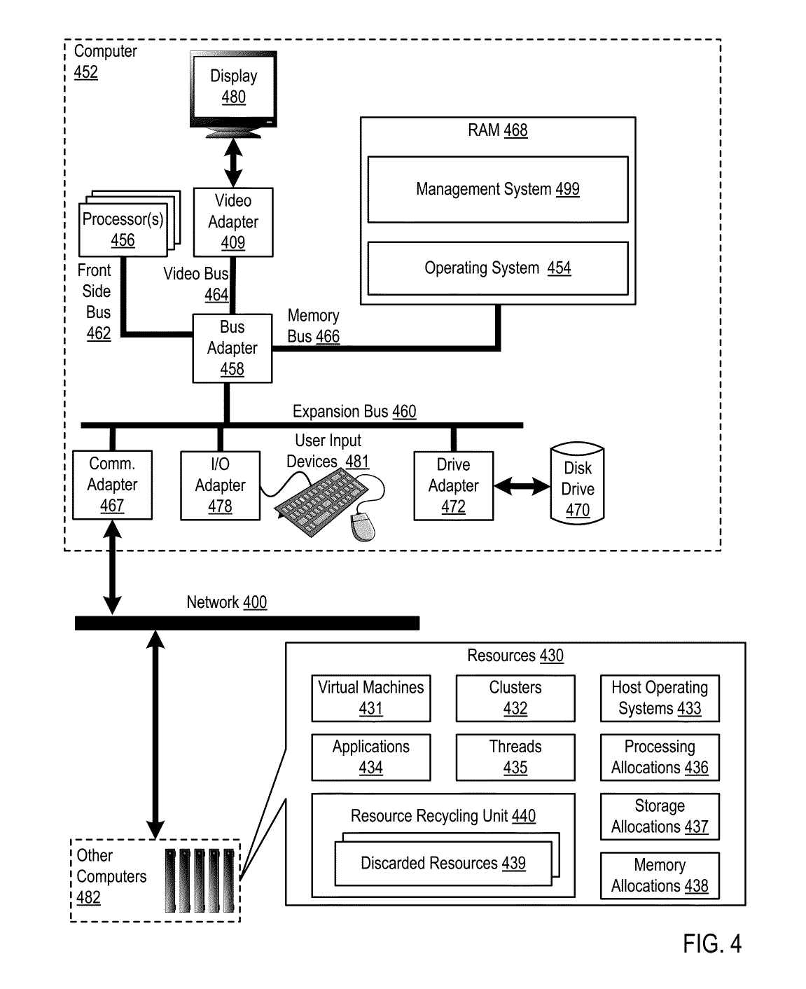

For further explanation, FIG. 4 sets forth a block diagram of automated computing machinery comprising an example computer useful in managing resources in a distributed computing environment according to embodiments of the present invention. The computer (452) of FIG. 4 includes at least one computer processor (456) or ‘CPU’ as well as random access memory (468) (‘RAM’) which is connected through a high speed memory bus (466) and bus adapter (458) to processor (456) and to other components of the computer (452).

Stored in RAM (468) is a management system (499), a module of computer program instructions that, when executed causes the computer (452) of FIG. 4 to manage resources of a distributed computing environment. In the example of FIG. 4, a distributed computing environment (not shown) is created on components of other computers (482). The management system may also be configured to administer provisioning and recycling of virtual machines, cloud resources, memory, and the like; track customer or user usage of cloud resources; provide a systems management interface for configuration of virtual machine environments; and so on.

Examples of such resources include but are not limited to virtual machines (431), clusters (432) of hardware devices or virtualized hardware, host operating systems (433), applications (434), threads or processes (435), processing allocations (436), storage allocations (436), memory allocations (438), and so on as will occur to readers of skill in the art. Other resources may also be included in a distributed computing environment such as virtual patterns (grouping of multiple virtual resources that work together, such as VMs), virtual networks, virtual bridges, virtual applications, virtual disk as well as pools of such various resources. In the example of FIG. 4, several resources (430) may be executed, instantiated, hosted, virtualized, or implemented by other computers (482) coupled via a data communications network (400) to the computer (452). Also, users (not shown here) may be coupled via one or more data communications network (400) to utilize the resources (430).

In the example of FIG. 4, the management system (499) may manage the resources (430) of the distributed computing environment in accordance with embodiments of the present invention by maintaining within a resource recycling unit (440), a plurality of discarded resources (439) of the distributed computing environment. The management system (499) is also configured to receive from a user, a request for a resource of the distributed computing environment and in response to receiving the request, select a first discarded resource from the plurality of discarded resources (439) of the resource recycling unit (440). The management system is also configured to provide the selected first discarded resource to a user. In an embodiment, the other computers (482) may be contained in the same physical box as the example computer (452) such as the IBM Blue Gene computer, or the IBM Flex computer. Readers of skill in the art will realize that the management system, the other computers and the distributed computing environment may be configured in a variety of other manners with other components, systems, and networks other than the ones shown in FIG. 4.

Also stored RAM (468) of the computer (452) is an operating system (454). Operating systems useful for managing resources in a distributed computing environment according to embodiments of the present invention include UNIX™, Linux™, Microsoft XP™, AIX™, IBM's i5/OS™, and others as will occur to those of skill in the art. The operating systems (454) and the management system (499) in the example of FIG. 4 are shown in RAM (468), but many components of such software typically are stored in non-volatile memory also, such as, for example, on a disk drive (470).

The computer (452) of FIG. 4 includes disk drive adapter (472) coupled through expansion bus (460) and bus adapter (458) to the processors (456) and other components of the computer (452). Disk drive adapter (472) connects non-volatile data storage to the computer (452) in the form of the disk drive (470). Disk drive adapters useful in computers for managing resources of a distributed computing environment according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (452) of FIG. 4 includes one or more input/output (‘I/O’) adapters (478). I/O adapters implement user-oriented input/output through, for example, software drivers and computer hardware for controlling output to display devices such as computer display screens, as well as user input from user input devices (481) such as keyboards and mice. The example computer (452) of FIG. 4 includes a video adapter (409), which is an example of an I/O adapter specially designed for graphic output to a display device (480) such as a display screen or computer monitor. The video adapter (409) is connected to the processors (456) through a high speed video bus (464), bus adapter (458), and the front side bus (462), which is also a high speed bus.

The exemplary computer (452) of FIG. 4 includes a communications adapter (467) for data communications with the other computers (482) and for data communications with the data communications network (400). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for managing resources in a distributed computing environment according to embodiments of the present invention include modems for wired dial-up communications, Ethernet (IEEE 802.3) adapters for wired data communications, and 802.11 adapters for wireless data communications.

The arrangement of computers and other devices making up the exemplary system illustrated in FIG. 4 are for explanation, not for limitation. Data processing systems useful according to various embodiments of the present invention may include additional databases, servers, routers, other devices, and peer-to-peer architectures, not shown in FIG. 4, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 4.

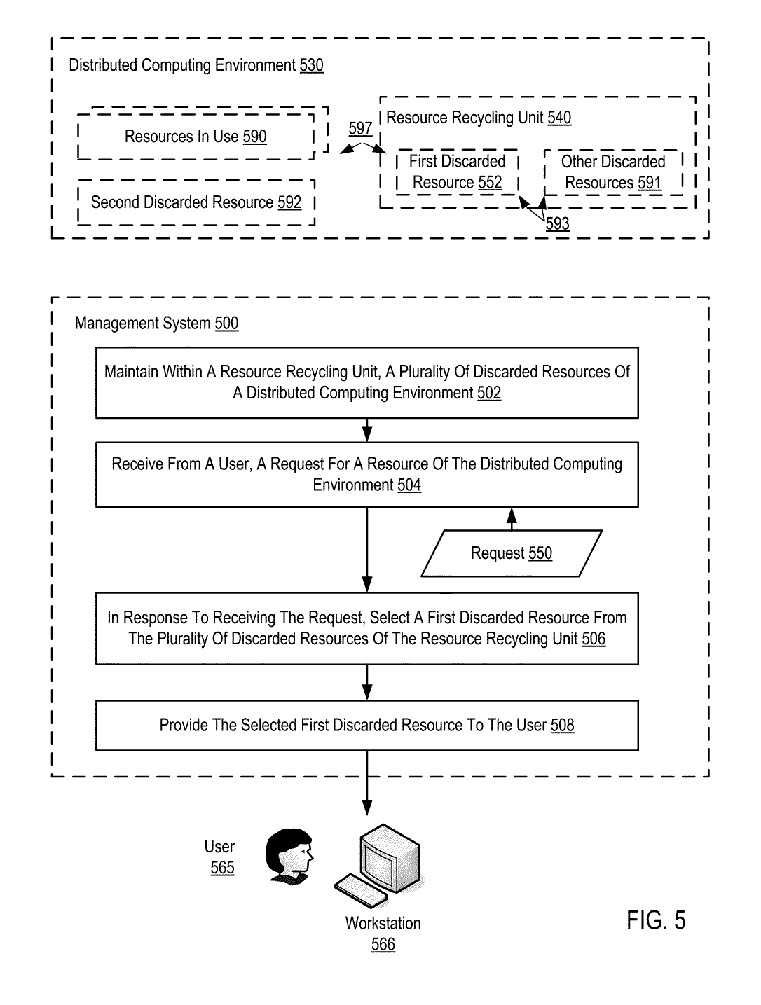

For further explanation, FIG. 5 sets forth a flow chart illustrating an exemplary method for managing resources of a distributed computing environment according to embodiments of the present invention. A distributed computing environment refers to a collection of computers, networks, and automated computing machinery configured to perform distributed processing. A non-limiting example of a distributed computing environment includes a cloud environment having a virtualized computing platform in which a user may be provided access to computing resources without knowledge, ownership, or physical access to the computer resources. The hardware, software, and capabilities of the components of a distributed computing environment or cloud environment may be offered to users as services or objects and may generally be referred to as resources. Non-limiting examples of resources include virtual machines, virtual pattern, processing clusters, host operating systems, applications, processing threads, processing allocations, storage allocations, memory allocations, and any many others as will occur to readers of skill in the art.

In the example of FIG. 5, the distributed computing environment (530) includes a plurality (597) of resources. The plurality (597) of resources includes resources (590) that are in use by users of the distributed computing environment (530) as well as discarded resources (592, 552, 591). The distributed computing environment (530) of FIG. 5 also includes a resource recycling unit (540) for storing particular resources that have been discarded by a user. How a particular resource in the resource recycling unit (540) is stored may depend on the type of resource and based on preferences specifying storage conditions of resources. For example, some resources may be provided full power, some resources may be stored in a low power state, some resources may be offline, and other may be compressed, encrypted, or some combination.

The method of FIG. 5 includes a management system (500) maintaining (502) within a resource recycling unit (540), a plurality (593) of discarded resources of the distributed computing environment (530). Maintaining (502) within a resource recycling unit (540), a plurality (593) of discarded resources of the distributed computing environment (530) may be carried out by setting time constraints for a particular resource to stay within the resource recycling unit (540), periodically determining if a particular resource should remain in the resource recycling unit (540); and controlling and setting power levels provided to a resource in the resource recycling unit (540).

The method of FIG. 5 also includes the management system (500) receiving (504) from a user (565), a request (550) for a resource of the distributed computing environment (530). Receiving (504) from a user (565), a request (550) for a resource of the distributed computing environment (530) may be carried out via data communications across one or more data communications networks. It is noted that in some environments according to embodiments of the present invention, all resource requests must initially be sent to the management system in some form. In some embodiments, the requesting user may send the request directly to the management system, while in other environments a hypervisor supporting one or more virtual machines handles the initial access request and passes along the requests to the management system to be processed for access control measures.

The method of FIG. 5 also includes the management system (500) selecting (506), a first discarded resource (552) from the plurality (593) of discarded resources of the resource recycling unit (540) in response to receiving a request (550). Selecting (506), a first discarded resource (552) from the plurality (593) of discarded resources of the resource recycling unit (540) in response to receiving the request (550) may be carried out by identifying a resource that meets criteria associated with the request. For example, a request may specify use of a particular application. If an instance of the requested application is available in the resource recycling unit, the management system may select that instance of the application. Requests may also include additional criteria, such as preloaded specific configuration data or association with a specific business entity. For example, a request may specify a storage allocation that was previously used by the same company of the user making the request.

The method of FIG. 5 also includes providing (508) the selected first discarded resource (552) to the user (565). Providing (508) the selected first discarded resource (552) to the user (565) may be carried out by identifying the selected resource to the user; presenting a user with an option to procure the selected resource; receiving user input indicating acceptance of the selected resource; and assigning the selected first discarded resource to the user. Providing (508) the selected first discarded resource (552) to the user (565) may also be carried out by importing valid licenses to an application. That is, by implementing a resource recycling unit in a distributed computing environment, vast performance improvements and time savings may be realized by recycling the discarded resources in response to a request for a new resource instead of creating that new resource.

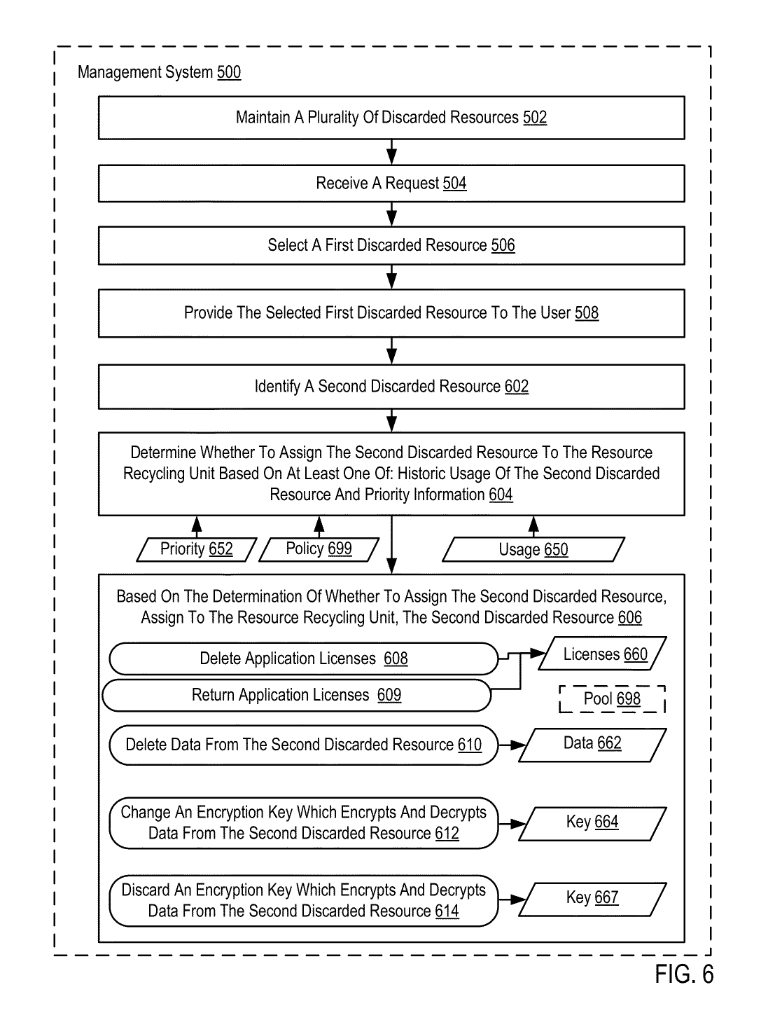

For further explanation, FIG. 6 sets forth a flow chart illustrating another example method for managing resources of a distributed computing environment according to embodiments of the present invention. The method of FIG. 6 is similar to the method of FIG. 5 in that the method of FIG. 6 also includes maintaining (502) within a resource recycling unit (540), a plurality (593) of discarded resources of the distributed computing environment (530); receiving (504) from a user (565), a request (550) for a resource of the distributed computing environment (530); in response to receiving the request (550), selecting (506), a first discarded resource (552) from the plurality (593) of discarded resources of the resource recycling unit (540); and providing (508) the selected first discarded resource (552) to the user (565).

The method of FIG. 6 also includes the management system (500) identifying (602), a second discarded resource (592) of the distributed computing environment (530). Identifying (602), a second discarded resource (592) of the distributed computing environment (530) may be carried out by receiving an indication that a user has discarded a resource.

The method of FIG. 6 also includes the management system (500) determining (604) whether to assign the second discarded resource (592) to the resource recycling unit (540) based on at least one of: historic usage (650) of the second discarded resource (592), priority information (652), and policy information (699). Historic usage is data indicating past use of the resource by a user. Historic usage data may also include additional information including circumstances surrounding the use of the resource. Examples of circumstance data that may be included in the historic use include but are not limited to time stamp data; user information; and additional resource usage data. Priority information indicates a relative importance of the resource to another resource. Priority information may indicate a relative importance to all users or a specific user. For example, a first resource may be more important to a user than a second resource. Continuing with this example, if there is only enough space for one resource but both the first resource and the second resource have been discarded, the management system may determine that the first resource should be recycled and the second resource should not. A policy information may specify whether a resource should be recycled or not. For example, particular policy information may specify that a resource is associated with a high security operation and is not to be saved. As another example, particular policy information may specify that a resource is a general marketing website and should always be recycled.

Determining (604) whether to assign the second discarded resource (592) to the resource recycling unit (540) based on at least one of: historic usage (650) of the second discarded resource (592) and priority information (652) may be carried out by determining whether the resource is likely to be reused by a user; determining whether the resource is likely to be reused within a particular period of time; and determining whether the resource should be recycled based on specific resource recycling rules. Resource recycling rules may be created based on historic data, priority data, or any other additional customer requirements specifying parameters for consideration of whether to recycle a resource, such as expense and time.

The method of FIG. 6 also includes the management system (500) assigning (606) to the resource recycling unit (540), the second discarded resource (592) based on the determination of whether to assign the second discarded resource (592). Assigning (606) to the resource recycling unit (540), the second discarded resource (592) may be carried out by performing one or more recycling preparation operations, such as data and configuration information removal; moving the resource to another portion of the distributed computing environment; and adjusting power consumption of the resource.

The method of FIG. 6 also sets forth several examples of ways to carry out assigning (606) the second discarded resource (592) to the resource recycling unit (540). Although the method of FIG. 6 sets forth several example methods for assigning (606) the second discarded resource (592) to the resource recycling unit (540), readers of skill in the art will recognize that any combination of these methods, as well as other methods not shown here, is well within the scope of the present invention.

In the method of FIG. 6, assigning (606) to the resource recycling unit (540), the second discarded resource (592) may include deleting (608) application licenses (660) of the second discarded resource (592). Deleting (608) application licenses (660) of the second discarded resource (592) may be carried out by as part of a fast clean process in which only the licenses are deleted so that the application will not start. As part of providing the resource to a user during recycling and reassignment, the management system may import a new license for the application.

In the method of FIG. 6, assigning (606) to the resource recycling unit (540), the second discarded resource (592) may include returning (609) application licenses (660) of the second discarded resource (592) to a license pool (698). Returning (609) application licenses (660) of the second discarded resource (592) to a license pool (698) may be carried out by as part of a fast clean process in which only the licenses are removed so that the application will not start. As part of providing the resource to a user during recycling and reassignment, the management system may import a new license for the application or retrieve a license from a license pool.

In the method of FIG. 6, assigning (606) to the resource recycling unit (540), the second discarded resource (592) may also include deleting (610) data (662) from the second discarded resource (592). Deleting (610) data (662) from the second discarded resource (592) may be carried out by leaving application data in a resource but deleting all additional user data.

In the method of FIG. 6, assigning (606) to the resource recycling unit (540), the second discarded resource (592) may also include changing (612) an encryption key (664) which encrypts and decrypts data from the second discarded resource (592). Changing (612) an encryption key (664) which encrypts and decrypts data from the second discarded resource (592) may be carried out by modifying the encryption key such that the key cannot be used to access any encrypted data in the resource. Because the key is changed, the data on the resource is inaccessible to another resource and may therefore be left in the resource. For example, if a resource includes network storage, the management system may save energy and time by skipping deletion of the encrypted data on the network storage and simply changing the key.

In the method of FIG. 6, assigning (606) to the resource recycling unit (540), the second discarded resource (592) may also include discarding (614) an encryption key (667) which encrypts and decrypts data from the second discarded resource (592). Discarding (614) an encryption key (667) which encrypts and decrypts data from the second discarded resource (592) may be carried out by deleting the encryption key such that a new user of the resource (after recycling) cannot access any encrypted data in the resource. For example, if a resource includes network storage, the management system may save energy and time by skipping deletion of the encrypted data on the network storage and simply deleting the key.

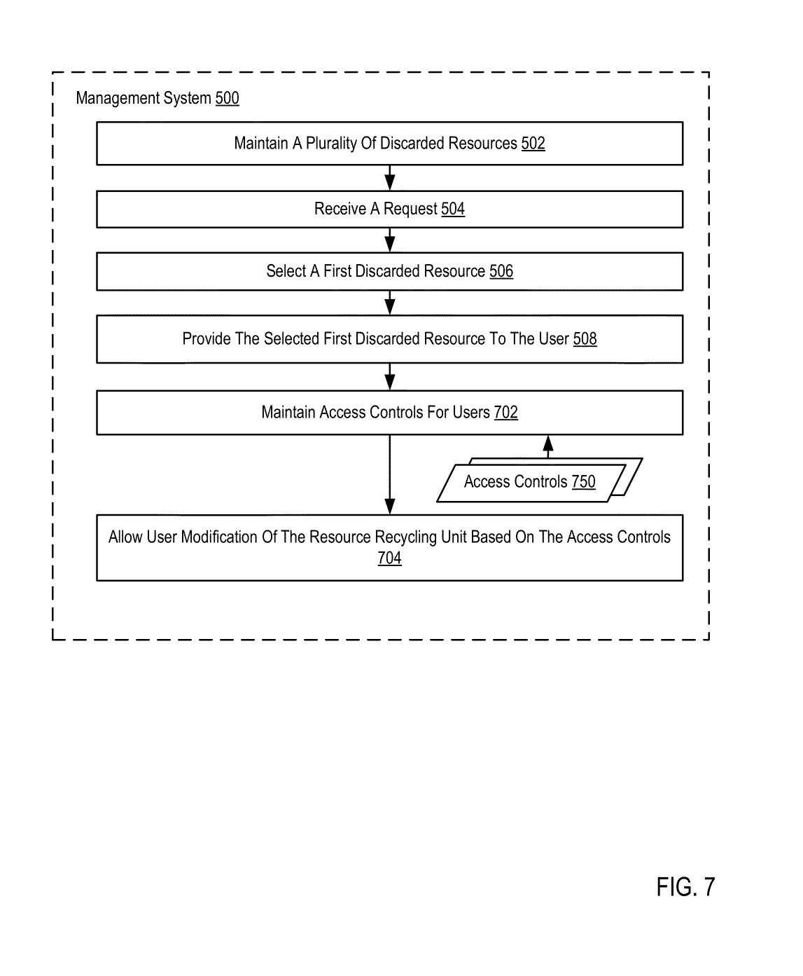

For further explanation, FIG. 7 sets forth a flow chart illustrating another example method for managing resources of a distributed computing environment according to embodiments of the present invention. The method of FIG. 7 is similar to the method of FIG. 5 in that the method of FIG. 7 also includes maintaining (502) within a resource recycling unit (540), a plurality (593) of discarded resources of the distributed computing environment (530); receiving (504) from a user (565), a request (550) for a resource of the distributed computing environment (530); in response to receiving the request (550), selecting (506), a first discarded resource (552) from the plurality (593) of discarded resources of the resource recycling unit (540); and providing (508) the selected first discarded resource (552) to the user (565).

The method of FIG. 7, however, also includes the management system (500) maintaining (702) access controls (750) for users. Maintaining (702) access controls (750) for users may be carried out by identifying one more access control measures to perform. Identifying one more access control measures to perform may be carried out in a variety of ways. For example, the attributes may be implemented as an index into a table or other data structure, where the value of the index points to a record representing an access control measure. Further, the record representing the access control measure may include many types of data in addition to the process to be performed. For example, the record may specify one or more identifiers of resources (an IP address, a Media Access Card address, a VM instance identifier, or other identifier) for which the access control measure process is to be performed if the any one of those identifiers is the identifier of the access request.

The method of FIG. 7 also includes allowing (704) user modification of the resource recycling unit (540) based the access controls (750). Allowing (704) user modification of the resource recycling unit (540) based the access controls (750) may be carried out by examining a record of access controls to determine if a user is authorized to modify the resource recycling unit; and tracking attempts by an unauthorized user to access the resource recycling unit.

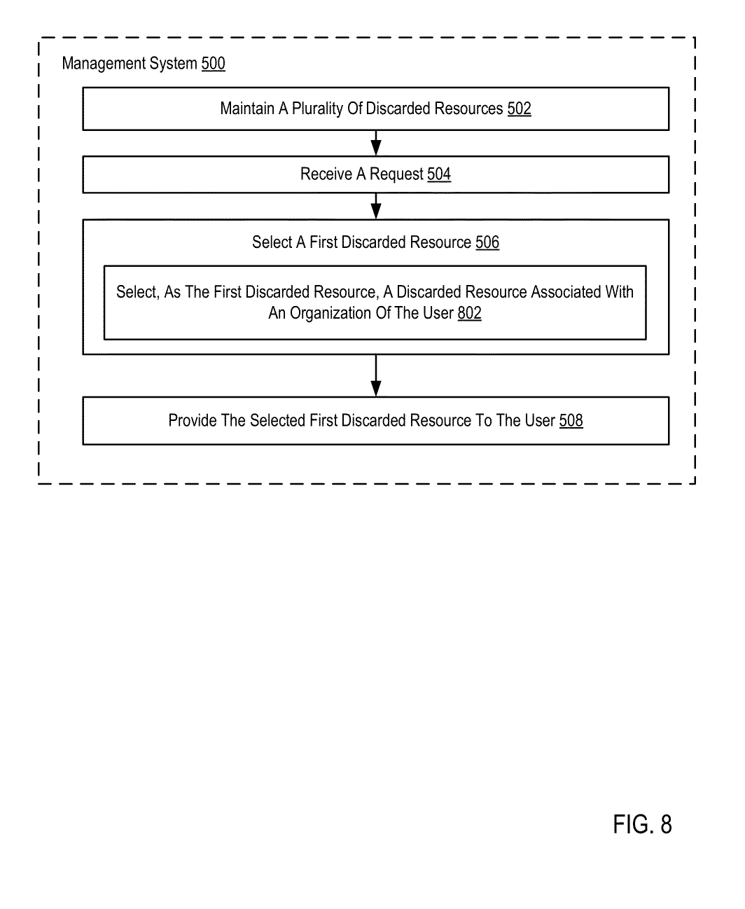

For further explanation, FIG. 8 sets forth a flow chart illustrating another example method for managing resources of a distributed computing environment according to embodiments of the present invention. The method of FIG. 8 is similar to the method of FIG. 5 in that the method of FIG. 8 also includes maintaining (502) within a resource recycling unit (540), a plurality (593) of discarded resources of the distributed computing environment (530); receiving (504) from a user (565), a request (550) for a resource of the distributed computing environment (530); in response to receiving the request (550), selecting (506), a first discarded resource (552) from the plurality (593) of discarded resources of the resource recycling unit (540); and providing (508) the selected first discarded resource (552) to the user (565).

In the method of FIG. 8, however, selecting (506), a first discarded resource (552) from the plurality (593) of discarded resources of the resource recycling unit (540) includes selecting (802), as the first discarded resource (552), a discarded resource associated with an organization of the user. Selecting (802), as the first discarded resource (552), a discarded resource associated with an organization of the user may be carried out by identifying a discarded resource within the resource recycling unit that matches both the type of resource requested and matches the organization of the user. For example, a user may want to only be provided recycled resources of the organization of the user and likewise may prevent the recycling of those resources to other organizations.

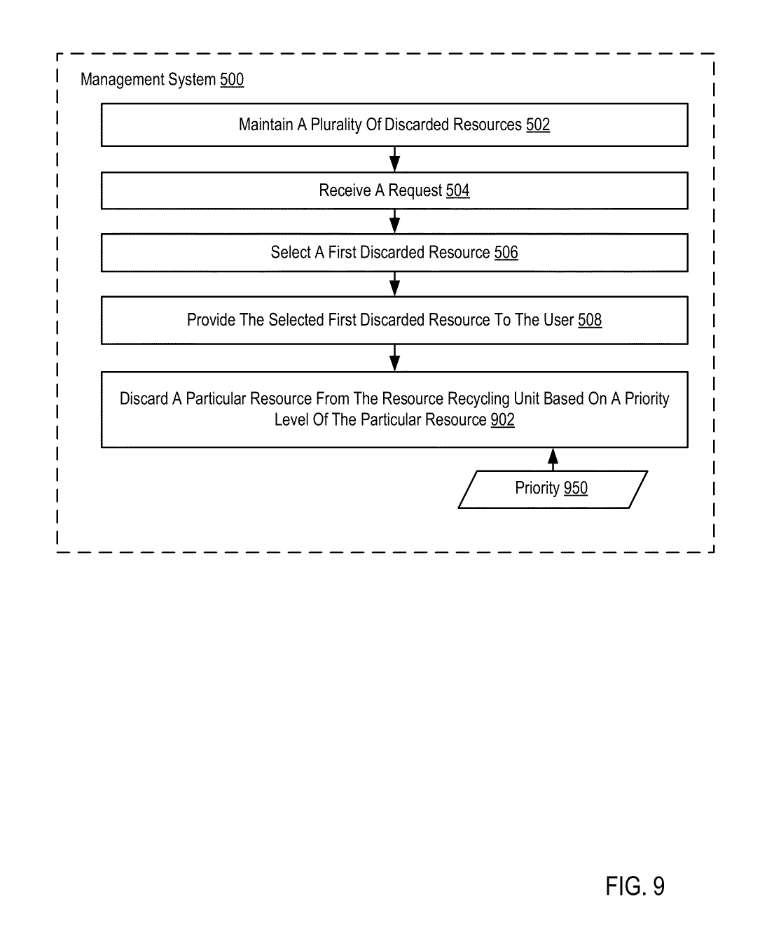

For further explanation, FIG. 9 sets forth a flow chart illustrating another example method for managing resources of a distributed computing environment according to embodiments of the present invention. The method of FIG. 9 is similar to the method of FIG. 5 in that the method of FIG. 9 also includes maintaining (502) within a resource recycling unit (540), a plurality (593) of discarded resources of the distributed computing environment (530); receiving (504) from a user (565), a request (550) for a resource of the distributed computing environment (530); in response to receiving the request (550), selecting (506), a first discarded resource (552) from the plurality (593) of discarded resources of the resource recycling unit (540); and providing (508) the selected first discarded resource (552) to the user (565).

The method of FIG. 9 also includes the management system (500) discarding (902) a particular resource from the resource recycling unit (540) based on a priority level (950) of the particular resource. A priority scheme may include identifying size of attributes of resource as part of determining which resources to remove from resource recycling unit. For example, attributes of a resource may be too large and take up too much space to recycle or too small to bother with overhead of recycling. A priority scheme may also include sorting resources based on time in recycling unit, reuse and recycle statistic; and general use statistics, and any other user priority scheme. Discarding (902) a particular resource from the resource recycling unit (540) based on a priority level (950) of the particular resource may be carried out by determining that the resource recycling unit has reached a storage capacity; identifying the oldest resource; identifying the resource used the least; and removing the resource from the resource recycling unit.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1-9. (canceled)

10. An apparatus for managing resources in a distributed computing environment, the distributed computing environment including a plurality of resources and a resource recycling unit for storing discarded resources, the apparatus including a computer processor and a computer memory operatively coupled to the computer processor, the computer memory having disposed within it computer program instructions that, when executed by the computer processor, cause the apparatus to carry out the steps of:
maintaining within a resource recycling unit, by a management system, a plurality of discarded resources of the distributed computing environment;
receiving from a user, by the management system, a request for a resource of the distributed computing environment;
in response to receiving the request, selecting, by the management system, a first discarded resource from the plurality of discarded resources of the resource recycling unit; and
providing, by the management system, the selected first discarded resource to the user.

11. The apparatus of claim 10 further comprising computer memory having disposed within it computer program instructions that, when executed by the computer processor, cause the apparatus to carry out the steps of:
identifying, by the management system, a second discarded resource of the distributed computing environment;
determining, by the management system, whether to assign the second discarded resource to the resource recycling unit based on at least one of: historic usage of the second discarded resource, policy information, and priority information; and
based on the determination of whether to assign the second discarded resource, assigning to the resource recycling unit, by the management system, the second discarded resource.

12. The apparatus of claim 11 wherein assigning the second discarded resource to the resource recycling unit includes deleting application licenses of the second discarded resource.

13. The apparatus of claim 11 wherein assigning the second discarded resource to the resource recycling unit includes deleting data from the second discarded resource.

14. The apparatus of claim 11 wherein assigning the second discarded resource to the resource recycling unit includes changing an encryption key which encrypts and decrypts data from the second discarded resource.

15. A computer program product for managing resources in a distributed computing environment, the distributed computing environment including a plurality of resources and a resource recycling unit for storing discarded resources, the computer program product disposed upon a computer readable storage medium, the computer program product comprising computer program instructions that, when executed, cause a computer to carry out the steps of:
maintaining within a resource recycling unit, by a management system, a plurality of discarded resources of the distributed computing environment;
receiving from a user, by the management system, a request for a resource of the distributed computing environment;
in response to receiving the request, selecting, by the management system, a first discarded resource from the plurality of discarded resources of the resource recycling unit; and
providing, by the management system, the selected first discarded resource to the user.

16. The computer program product of claim 15 further comprising computer program instructions that, when executed, cause a computer to carry out the steps of:
identifying, by the management system, a second discarded resource of the distributed computing environment;
determining, by the management system, whether to assign the second discarded resource to the resource recycling unit based on at least one of: historic usage of the second discarded resource, policy information, and priority information; and
based on the determination of whether to assign the second discarded resource, assigning to the resource recycling unit, by the management system, the second discarded resource.

17. The computer program product of claim 16 wherein assigning the second discarded resource to the resource recycling unit includes deleting application licenses of the second discarded resource.

18. The computer program product of claim 16 wherein assigning the second discarded resource to the resource recycling unit includes deleting data from the second discarded resource.

19. The computer program product of claim 16 wherein assigning the second discarded resource to the resource recycling unit includes changing an encryption key which encrypts and decrypts data from the second discarded resource.

20. The computer program product of claim 16 wherein assigning the second discarded resource to the resource recycling unit includes discarding an encryption key which encrypts and decrypts data from the second discarded resource.
